(19) United States
(12) Patent Application Publication
(10) Pub. No.: US 2002/0080710 A1
(43) Pub. Date: Jun. 27, 2002

(54) High speed/high density optical storage system using one-dimensional multi-function/multiple probe columns

(76) Inventors: Jeong Yong Kim, Daejon-Shi (KR); Kang Ho Park, Daejon-Shi (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/021,836

(22) Filed: Dec. 12, 2001

(30) Foreign Application Priority Data
Dec. 27, 2000 (KR) 2000-82806

(51) Int. Cl. G11B 11/08

(52) U.S. Cl. 369/126

(57) ABSTRACT

The present invention provides a technology of manufacturing and driving a high speed/high density optical storage system using one-dimensional multi-function/multiple probe columns. The present invention employs a scanning type multi-function probe to perform high-density data recording/reading in excess of a diffraction limit of light. Also, the present invention adopts a multiple probe array shape arranged in a row in order to be easily implemented with rotating disk media. Thus, as each of the probes divides data to perform recording/reading, the transfer rate of data can be increased by the number of the probes. Each of the probes is manufactured using electrical and thermal conductive materials and is attached to an AFM (atomic force microscopy) type cantilever. Thus, as a gap of the probes can be independently controlled, the probes can contact the media as necessary. Thereby, recording by light can be performed or recording can be performed using electricity or heat. Therefore, the present invention can significantly reduce the time required to record data and can variously select the type of recording media. Further, the present invention can implement high-density/high-speed optical probe data storage system.

### BACKGROUND OF THE INVENTION

1. Field of the Invention

The invention relates generally to a high speed/high density optical storage system using one-dimensional multi-function/multiple probe columns, and more particularly to, a high speed/high density optical storage system using one-dimensional multi-function/multiple probe columns capable of recording/reading high density data at high speed on a disk type recording medium using a multiple/multi-function near-field optical probe technology.

2. Description of the Prior Art

Today, a commercial technology of recording data on an optical disk such as CD or DVD records/reads data by focusing a laser light at a fine focus of about 1 μm while scanning a single optical head on a rotating optical disk. Thus, in order to obtain the data recording density required in a high resolution TV or an internet broadcasting, etc. which would be commercialized in the future, it is required that small recording/reading bit size of about several dozens of nm be implemented. In case of focusing laser using current optics, however, there is a physical limitation that the bit size smaller than the wavelength of used light could not be implemented due to diffraction of light. Therefore, in order to solve this problem, there recently been introduced a near-field optical data storage technology. The near-field optical data storage technology does not focus light using the lens but flows light into the probe having small apertures while controlling an atomic force between the probe and the media, so that recording bits smaller than the wavelength of light can be recorded/read with the probe in several dozens of nm from the surface of the media. The near-field optical data storage technology is based on the following principle: if light is flowed into the probe having small apertures at the end with the probes within several dozens of nm from the surface of the media, a light source much smaller than the wavelength of light is produced. This technology has been actively researched as a next-generation large-capacity optical data storage system since it can implement recording bit size of several dozens of nm. Meanwhile, as one similar to the above technology, it was reported that high density data recording of ˜Tbi/in² can be implemented by means of a method by which heat or an electric field is applied at a local position on a recording medium using a cantilever type probe of an atomic microscope. The data storage system using a scanning type probe employing this near-field optics or the atomic gap force, however, has a technical difficulty that the distance between the probe and the recording medium must be constantly maintained below several dozens of nm.

Generally, the data storage system using a scanning type probe measures the atomic gap force between the probe and the recording medium to control the gap using a signal from a feedback circuit. However, this method has the possibility that it will wears out the probe and data transfer rate is limited because the bandwidth of an electric circuit for controlling the gap limits the scanning speed of the media. Another problem is that the optical transmittance of the near-field probe is generally small below 10⁻³, it becomes another factor to degrade the recording rate because it requires a certain period of time to cause phase change on the recording medium when light is used. Therefore, in order to increase the recording/reading speed, a plurality of probes are generally employed to increase the data transfer rate. Of course, as data is dividedly recorded using the plurality of the probes, the data transfer rate can be increased in principle as the number of the probe.

Multi-probe data storage system, currently have been researched, uses two-dimensional probe column of a matrix shape [Binning et al. Appl. Phys. Lett. V. 74 1329-1331 (1999)]. However, this system has a difficulty in applying a rotation type disk, which is the most efficient media scanning method. And as the probe directly contacts the media when data is recorded/read, the system may cause error due to wear-out of the probe or vibration when data is recorded/read.

In order to raise the data transfer rate of the near-field optical data storage system to the degree of commercialization, the optical probe must be multiplied. To multiply an optical head using a light focusing method by the lens being an existing method was already proposed [U.S. Pat. No. 4,972,396 issued to David J. Rafner, etc.]. In the patent, as each of the optical heads is independently controlled, they can record and read data at the same time. Therefore, this patent is effective in performing multiple tasks and can thus increase the data transfer rate. Recently, there has been proposed a multi-beam optical recording/reading method using a two-dimensional plan array of semiconductor laser, vertical surface emitting laser [U.S. Pat. No, 5,808,986 issued to Jack L. Jewell, etc.]. An example of multiplying the near-field optical probe could be seen from a prior art [U.S. Pat. No. 6,101,165 issued to Motonobu Korogi, etc.]. This prior art can increase the data reading speed using two-dimensional matrix type probe column. These patents proposed a technology by which a contact pad at the edge of the near-field optical probe column of a plan array shape contacts the media to read recorded bits while scanning the disk. In this case, the gap between the probe and the media is controlled by the force physically pushing the probe column. Thus, a high speed scanning on the media can be achieved, which results in an increase of the data transfer rate. However, as the optical efficiency of the near-field optical probe is low (below 10⁻³), it is still a severe problem upon recording of data.

Because the optical recording speed is directly proportional to the amount of light illuminated. Therefore, additional recording mechanism other than photon mode recording is necessarily required for a high-speed recording.

### SUMMARY OF THE INVENTION

In order to solve the stated problems, a high speed/high density optical storage system using one-dimensional multi-function/multiple probe column according to the present invention is to provide a technology capable of selecting a recording mode using an electric field or heat as well as light when data is recorded, by integrating optical probes in one column in a radial direction of a media so that a conventional rotation type optical disk technology can be intact used and by selectively operating a cantilever type or a contact pad type for controlling the optical probes to contact the probes on the surface of the media always or intermittently.

In order to accomplish the above object, an optical data storage system capable of recording/reading optical data on a disk media is characterized in that it comprises multiple probe columns arranged in a row, wherein a region on which data can be recorded on the disk media which is divided into small tracks and large tracks, and the probe column between the small tracks and the large tracks is moved by a dual driving control device in which high resolution movement and low resolution movement are integrated.

An optical data storage system according to the present invention comprising: a disk media having small tracks and large tracks, a probe column driving arm; multiple probes arranged in a row, with the probes being attached to a free end of the probe column driving arm and moving in a radial direction of the disk media; and a dual driving control device to move the probes, with the dual driving control device having a high resolution transferring device capable of moving between the small tracks and a low resolution transferring device capable of moving between the large tracks.

Preferably, the probe includes a plurality of optical probes and AFM probes, the AFM probes record data using heat/electricity and control a gap between the disk media, and the optical probes record/read data using light.

Also, an optical data storage method capable of recording /reading optical data on a disk media is characterized in that a plurality of probes for recording/reading data are arranged in a row, wherein a column of the probes between small tracks on a media disk is moved by a transducer having a high resolution and a column of the probes between large tracks on the media disk are moved by a transducer having a low resolution.

### BRIEF DESCRIPTION OF THE DRAWINGS

The aforementioned aspects and other features of the present invention will be explained in the following description, taken in conjunction with the accompanying drawings, wherein:

FIG. 1 is a perspective view of a multi-function/multiple probe column according to one embodiment of the present invention, wherein the probe is controlled by a dual driving device on a disk media to record/read data;

FIG. 2 shows a state that multiple probe columns move spirally fine tracks on the media disk to record/read data;

FIG. 3 is a construction showing a single type probe to which a contact pad is attached according to one embodiment of the present invention; and

FIG. 4 is a construction showing a complex type probe where cantilever style gap control is implemented.

### DETAILED DESCRIPTION OF PREFERRED EMBODIMENTS

A high speed/high density optical storage system using one-dimensional multi-function/multiple probe column according to a preferred embodiment of the present invention will be described in detail with reference to accompanying drawings.

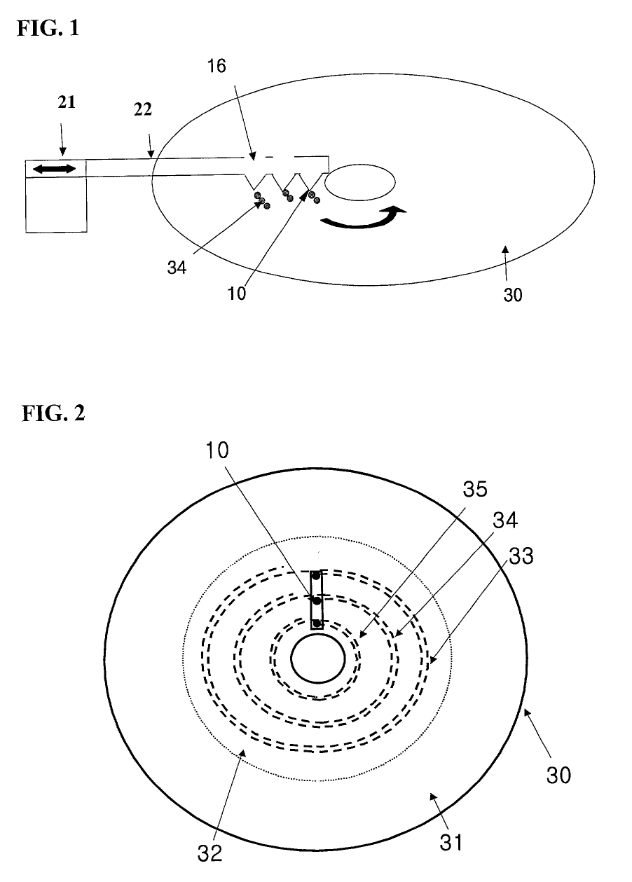

FIG. 1 is a perspective view of the multi-function/multiple probe column according to the present invention, wherein the probe is controlled by a dual driving device on a disk media to record/read data.

Referring now to FIG. 1, the optical storage system according to the present invention includes a plurality of probes 10, optical illuminating inlets 16, a dual driving control device 21, a probe column driving arm 22, a recording/reading disk media 30 and recording/reading bits 34.

The probes 10 have an exterior shape in which the probes 10 are arranged in one column. Each of the probes 10 is attached to a free end of the arm 22. The arm 22 is moved in a radial direction to the media disk 30 and records/reads data while the disk 30 is rotated. Each of the probes 10 has a light source and an optical detector and is independently controlled. It should be understood that the probes 10 can be made using electrical/thermal conductive materials or can have its surface coated with conductive materials to have electrical/thermal conductivity.

FIG. 2 shows a state that multiple probe columns move spirally fine tracks on the media disk to record/read data.

A mode of recording/reading data on tracks may include both a spiral mode and a concentric circle mode of CD or DVD, which have been presently commercialized. All data is divided to have the same amount to the number of the probes 10, so that the same amount of data can be simultaneously transmitted to respective probes 10. Data recording region on the disk 30 is divided into small tracks 33-35 and large tracks 31 and 32. The small tracks 33-35 indicate fine tracks being the minimum unit for recording/reading data. The large tracks 31 and 32 indicate tracks having a size similar to the width of the probes 10 column. For example, if the width of the probes 10 column (distance from the first probe to the last probe) is 1 mm and the radius of a face of the disk 30 on which data can be recorded is 10 mm, it means that there are 10 large tracks 31 and 32. As the distance between all the probes 10 is constant, a region for which respective probes 10 are responsible for recording and reading is up to the first track in an immediately neighboring probe 10. If the distance between the probes 10 is 50 μm and the distance between the tracks 50 nm, it means that there are 1000 small tracks 33-35 between the probes 10. If all the small tracks 33-35 existing between the probes 10 are completely scanned, the probe 10 column should be moved in a radial direction of the disk 30 by the length to the probe 10 column.

Therefore, in order to record/read data on the small tracks 33-35 between the probes 10, it is required that a transducer having a high resolution of several nm be provided. In order to move between the large tracks 31 and 32, a long distance transducer having a low resolution but capable of moving several mm is required. In other words, a dual transducer is required. As the high resolution transducer has a short moving range of several tens of μm but has a resolution of several nm, it is suitable for control using piezoelectric materials. The low resolution transducer uses a driving device of a conventional optical data storage system such as a voice coil. The weight and size of the optical head that focuses light to and collects light from the probe array is minimized through MEMS (micro-electronic mechanical system) technology. When the probe 10 is used to control a signal and to record data, the recording/reading frequencies of each of the probes 10 are designed to be same for the purpose of the efficiency of integration upon distribution and data reproduction. As the scanning speed between the probe 10 located inmost the probe 10 column and the probes 10 located outmost the probe 10 column is different, the outermost track has a greater distance between the bits than the inmost track. Thus, there is some possibility that the recording/reading data density may be degraded. However, an effect on the recording/reading density can be minimized by designing the length of the probe 10 column to be small compared to the size of the disk. For example, assuming that the distance between the probes 10 is 50 μm and the number of the probes 10 is 20, the distance between the inmost probe and the outermost probe is about 1 mm. Therefore, as degradation of the recording density by the outermost probe in a large track having the radius of 10 mm is about 10%, an effect on the entire recording density is very few.

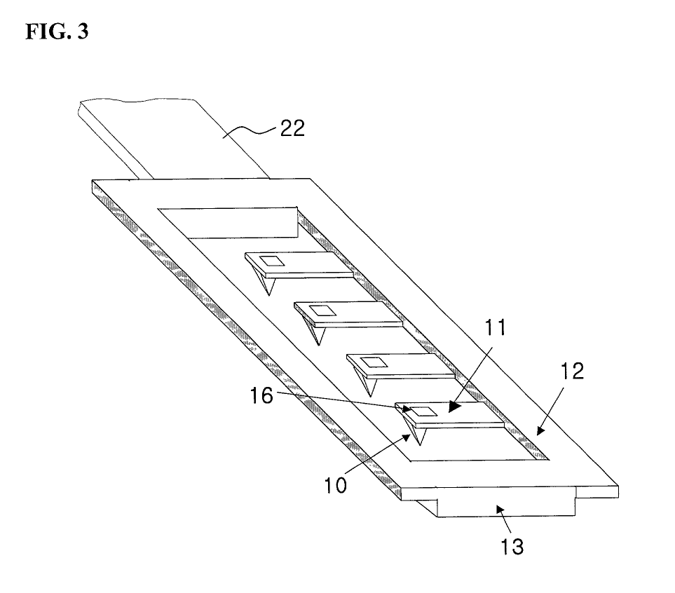

FIG. 3 is a construction showing a single type probe to which a contact pad is attached according to one embodiment of the present invention.

As can be seen from FIG. 3, an optical aperture 16 having a several dozens of nm in size is located at an end of the probes 10. The probes 10 may be manufactured using electrical/thermal conductive materials or may have its surface coated with conductive materials to have electrical/thermal conductivity. When data is read, recorded data is read at high speed by scanning the light through the probe 10 on the media 30. When data is recorded, data is recorded by controlling the cantilever 11 to apply electricity or heat to the media 30. Each of the probes 10 is manufactured on the AFM (atomic force microscopy) type cantilever 11 made of piezoelectric materials and a vertical position of the probes 10 can be also adjusted by detecting the atomic gap force. Therefore, each of the probes 10 can be independently controlled to contact the media 30 when electricity or heat is transmitted to the media 30. The atomic gap force between the probes 10 and the media 30 can be measured, by sensing an electric signal generated in proportion to the deflection of the cantilever 11 or reflecting a laser light using a conventional deflection detection scheme of AFM cantilever.

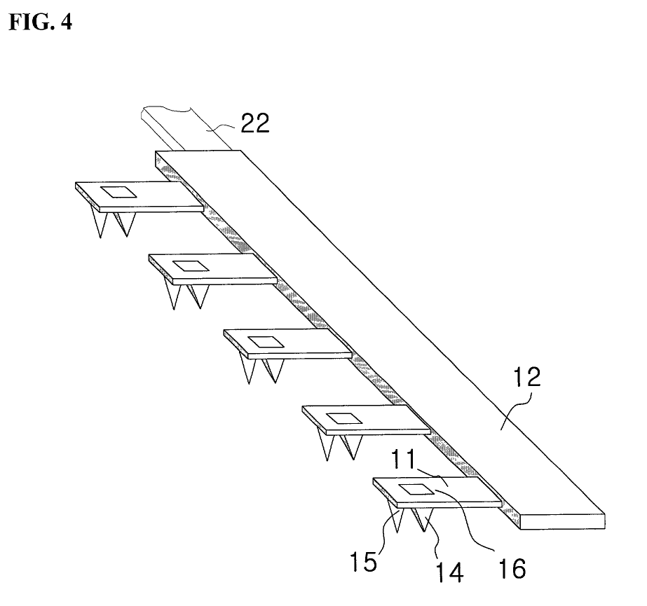

FIG. 4 is a construction showing a complex type probe where cantilever style gap control is implemented. The complex type probe according to the present invention includes an optical probe 14 having an aperture 16, and a AFM probe 15 having no aperture, both of which form a single cantilever 11. The AFM probe 15 may be made using electrical/thermal conductive materials or have its surface coated. The difference in the length between both the probes 14 and 15 must be below several dozens of nm. Therefore, the AFM probe 15 can maintain the spatial resolution of the optical probe 14 when it contacts the surface of the media 30 by allowing the optical probe 14 to be located at the near-field region. As the cantilever 11 is coated with piezoelectric materials, the vertical position of the cantilever 11 can be electrically controlled. Or the gap can be controlled, by reflecting laser light off the cantilever 11 and reading the deflection of the cantilever 11 and measuring the atomic force. The AFM probe 15 controls the gap and uses heat/electricity to record data. The optical probe 14 is responsible for recording/reading data using light. This type of structural characteristic can minimize the size of recording bits since the topographic resolution of the AFM probe 15 having no optical aperture is better than the optical probe 14. Also, as the AFM probe 15 is responsible for the gap control, this type of structural characteristic can maintain the resolution of the optical probe 14 since the optical probe 14 is not worn out due to repetitive data reproduction.

As can be seen from the description, a high speed/high density optical storage system using one-dimensional multi-function/multiple probe column according to the present invention has an advantage that it can be used with rotating disk media in recording/reading data in excess of the diffraction limit of light by recording/reading data using the probes. The present invention can significantly increase the data recording speed using multi-function probes capable of applying electricity or heat and illuminating light. According to the present invention, as various recording mechanism other than optical recording can be adopted, the type of-media can be easily selected. Also, as several probes can simultaneously record/read using multi-probe array, data transfer rate can be increased by the number of the probes over using a single probe.

The present invention has been described with reference to a particular embodiment in connection with a particular application. Those having ordinary skill in the art and access to the teachings of the present invention will recognize additional modifications and applications within the scope thereof

It is therefore intended by the appended claims to cover any and all such applications, modifications, and embodiments within the scope of the present invention.

What is claimed is:

1. An optical data storage system capable of recording/reading optical data on a disk media, comprising:
multiple probe columns arranged in a row,
wherein a region on which data can be recorded on the disk media, which is divided into small tracks and large tracks,
said probe column between the small tracks and the large tracks is moved by a dual driving control device in which high resolution movement and low resolution movement are integrated.

2. The optical data storage system as claimed in claim 1, wherein said probe column has a plurality of probes arranged in a row at one end within a probe column support.

3. The optical data storage system as claimed in claim 2, wherein said probe column is moved in a radial direction on the disk while the disk is rotated and records/reads in a spiral shape or a concentric circle shape.

4. The optical data storage system as claimed in claim 2, wherein said probe includes a plurality of optical probes and AFM probes, said AFM probes control a gap the disk media and record data using heat/electricity, and said optical probes record/read data using light.

5. The optical data storage system as claimed in claim 4, wherein said AFM probes are made to be longer than said optical probes by several dozens of nm and arranged in a row at one end of the probe column support to form a probe column.

6. The optical data storage system as claimed in claim 4, wherein said AFM probes are made with electrical or thermal conductive materials or have its surface coated with electrical or heat conductive materials so that the probes can conduct electricity or heat.

7. The optical data storage system as claimed in claim 4, wherein said AFM probes record data on the disk by making phase change or prominence and depression using electricity/heat, and said optical probes read data by reading the difference in the reflectivity or transmittance using light.

8. The optical data storage system as claimed in claim 4, wherein said AFM probes record/read data by controlling a gap based on measurement of an atomic force on the disk media.

9. An optical data storage method capable of recording/reading optical data on a disk media being characterized in that:
a plurality of probes for recording/reading data are arranged in a row,
wherein a column of the probes between small tracks on a media disk is moved by a transducer having a high resolution and a column of the probes between large tracks on the media disk are moved by a transducer having a low resolution.

10. An optical data storage system comprising:
a disk media having small tracks and large tracks,
a probe column driving arm;
multiple probes arranged in one dimension, with said probes being attached to a free end of said probe column driving arm and moving in a radial direction of said disk media; and
a dual driving control device to move said probes, with said dual driving control device having a high resolution transferring device capable of moving between said small tracks and a low resolution transferring device capable of moving between said large tracks.

11. The system of claim 10, wherein said probes are arranged in a row at one end, with each of said probes have an optical aperture.

12. The system of claim 10, wherein said high resolution transferring device is controlled by piezoelectric materials.

13. The system of claim 10. Wherein said low resolution transferring device is controlled by a voice coil.

14. The system of claim 10, wherein said probes comprises a plurality of AFM probes and optical probes which are manufactured in cantilevers by one pair, with said cantilevers having an aperture.
